(19) United States
(12) Patent Application Publication
(10) Pub. No.: US 2019/0003648 A1
(43) Pub. Date: Jan. 3, 2019

(54) Method for Cooling a First Cryogenic Pressure Vessel

(71) Applicant: Bayerische Motoren Werke Aktiengesellschaft, Muenchen (DE)

(72) Inventors: Jan-Mark KUNBERGER, Muenchen (DE); Simon Hettenkofer, Muenchen (DE)

(21) Appl. No.: 16/115,133

(22) Filed: Aug. 28, 2018

Related U.S. Application Data
(63) Continuation of application No. PCT/EP2017/050659, filed on Jan. 13, 2017.

(30) Foreign Application Priority Data
Feb. 29, 2016 (DE) 10 2016 203 200.3

(51) Int. Cl. F17C 5/06; B60K 15/03; F17C 13/02; F17C 1/12

(52) U.S. Cl. CPC F17C 5/06; F17C 2250/072; F17C 13/026; F17C 1/12; F17C 13/025; B60K 2015/03328; F17C 2270/0168; F17C 2250/0439; F17C 2223/036; F17C 2203/0391; F17C 2221/012; F17C 2221/033; F17C 2250/043; F17C 2205/0134; F17C 2205/0332; F17C 2223/0161; F17C 2227/0339; B60K 15/03

(57) ABSTRACT

A method for cooling a first cryogenic pressure vessel, where the first cryogenic pressure vessel is designed for the storage of cryogenic gas, includes firstly conducting gas through the first pressure vessel for the purposes of cooling the first pressure vessel and subsequently feeding the gas to a second pressure vessel for the purposes of storing the gas, until the temperature of the first pressure vessel has reached a predetermined temperature value or until the second pressure vessel has reached a predefined degree of filling with gas.

### CROSS REFERENCE TO RELATED APPLICATIONS

This application is a continuation of PCT International Application No. PCT/EP2017/050659, filed Jan. 13, 2017, which claims priority under 35 U.S.C. § 119 from German Patent Application No. 10 2016 203 200.3, filed Feb. 29, 2016, the entire disclosures of which are herein expressly incorporated by reference.

### BACKGROUND AND SUMMARY OF THE INVENTION

The invention relates to a method for cooling a first cryogenic pressure vessel, to a further method for cooling a first cryogenic pressure vessel, and to a pressure vessel system comprising a first cryogenic pressure vessel for the storage of cryogenic gas and a second pressure vessel for the storage of gas.

Cryogenic pressure vessel systems are known from the prior art. They comprise cryogenic pressure vessels. A pressure vessel of the type comprises an inner vessel and an outer vessel which surrounds the inner vessel so as to form a superinsulated (e.g., evacuated) (intermediate) space. Cryogenic pressure vessels or pressure tanks are used for example for motor vehicles in which a fuel which is gaseous under ambient conditions is stored cryogenically, and thus in the liquid or supercritical state of aggregation, that is to say substantially with a much higher density in relation to the ambient conditions. Therefore, highly effective insulating casings (e.g., vacuum casings) are provided. For example, EP 1 546 601 B1 discloses a pressure vessel of the type.

Cryogenic pressure vessels can store more gas the colder the pressure vessel is. In particular in the case of relatively long standstill periods of the pressure vessel, that is to say for example of the motor vehicle in which the pressure vessel is arranged, the temperature of the pressure vessel, and consequently the temperature of the gas in the pressure vessel, can greatly increase.

By means of the discharge of gas out of the pressure vessel, the pressure and the temperature of the gas, and consequently the temperature of the pressure vessel, decrease. However, if only little gas is present in the pressure vessel and a relatively long standstill period of the motor vehicle occurs, then even during the consumption of the remaining gas, that is to say the discharge of the remaining gas from the pressure vessel, this can cool the pressure vessel only very slightly. Thus, the pressure vessel is at a relatively high temperature during a tank filling process or refilling process. This has the effect that only little gas can be received in the pressure vessel or fed to the pressure vessel. As a result, the range of the motor vehicle having the pressure vessel is short.

It is an object of the technology disclosed here to reduce or eliminate the disadvantages of the previously known solutions. Further objects will emerge from the advantageous effects of the technology disclosed here.

Thus, the object is achieved by means of a method for cooling a first cryogenic pressure vessel, wherein the first cryogenic pressure vessel is designed for the storage of cryogenic gas, wherein gas is firstly conducted through the first pressure vessel for the purposes of cooling the first pressure vessel and is subsequently fed to a second pressure vessel for the purposes of storing the gas, until the temperature of the first pressure vessel has reached a predetermined temperature value or until the second pressure vessel has reached a predefined degree of filling with gas.

An advantage of this is that the first cryogenic pressure vessel is cooled and the gas that is warmed as a result of the cooling of the first cryogenic pressure vessel does not remain in the first pressure vessel, but is rather conducted into the second pressure vessel. Only when the first pressure vessel has been adequately cooled, that is to say when the gas is no longer significantly heated by the first pressure vessel, or when the second pressure vessel has reached a certain fill level or degree of filling, is the gas no longer conducted through the first pressure vessel into the second pressure vessel. After the end conditions for the conducting of the gas through the first pressure vessel into the second pressure vessel have been attained, the gas can subsequently be conducted for example into the first pressure vessel and remain or be stored there. Thus, during a tank filling process, the first pressure vessel can be (additionally) cooled for the (cryogenic) gas filling. At the end of the cooling, or when the end condition is attained, the first pressure vessel is thus at a lower temperature than in the absence of additional cooling by means of the cold gas, whereby a greater tank filling density can be achieved. The cryogenic or cold gas is warmed as a result of the exchange of heat with the vessel and can be stored virtually without losses in the second, warm pressure vessel. In this way, conditioning of the first (cryogenic) vessel is realized, in which first vessel the fraction of warmed gas that has been used for the cooling of the first pressure vessel is thus minimized. As a result of this, that is to say in particular the low temperature of the pressure vessel, the amount of gas that can be stored in the first pressure vessel (in the case of the same tank filling pressure) increases. This leads to an increased range of a motor vehicle in which the pressure vessel may be arranged.

The predefined temperature may be the temperature of the gas before the gas is introduced into the first pressure vessel. Thus, gas is conducted through the first pressure vessel until the first pressure vessel has (aside from any insulation losses) reached the temperature of the gas (before the introduction into the first pressure vessel). When the first pressure vessel has reached the temperature, the gas can no longer cool the first pressure vessel, and the pressure vessel no longer warms the gas. An advantage of this is that the amount of gas that can be stored in the pressure vessel is particularly greatly increased.

The gas may be warmed after flowing through the first pressure vessel, before the gas is fed to the second pressure vessel. In this way, the gas can be stored in the second pressure vessel in the warm state. If the second pressure vessel is designed for storing CGH2, the gas can thus be conducted into the second pressure vessel, and stored there, in the warm state. An advantage of this is therefore that, firstly, the gas cools the first pressure vessel and, secondly, the same gas can subsequently be stored in the warm state in the second pressure vessel.

The gas may be cryogenic and/or supercritical gas before the gas is conducted through the first pressure vessel. An advantage of this is that a particularly large amount of gas can be stored in the first pressure vessel. Furthermore, the first pressure vessel is particularly intensely cooled.

The object is also achieved by means of a pressure vessel system comprising a first cryogenic pressure vessel for storing cryogenic gas and a second pressure vessel for storing gas, wherein the pressure vessel system is designed such that, for the purposes of cooling the first pressure vessel, gas is firstly conducted through the first pressure vessel and is subsequently fed to the second pressure vessel, until the temperature of the first pressure vessel has reached a predetermined temperature value or until the second pressure vessel has reached a predefined degree of filling with gas.

An advantage of this is that the first cryogenic pressure vessel can be cooled, and the gas warmed as a result of the cooling of the first cryogenic pressure vessel can be conducted into the second pressure vessel rather than remaining in the first pressure vessel. Only when the first pressure vessel has been adequately cooled, that is to say when the gas is no longer significantly warmed by the first pressure vessel, or when the second pressure vessel has reached a certain fill level or degree of filling, is the gas no longer conducted through the first pressure vessel into the second pressure vessel. After the end condition for the conducting of the gas through the first pressure vessel into the second pressure vessel has been attained, the gas may subsequently for example be conducted into the first pressure vessel and remain therein. Thus, during a tank filling process, the first pressure vessel can firstly be cooled before being filled with gas, in particular cryogenic gas. In this way, the amount of gas that can be stored in the first pressure vessel increases. This leads to an increased range of a motor vehicle in which the pressure vessel may be arranged.

The object is also achieved by means of a method for cooling a first cryogenic pressure vessel, wherein the first cryogenic pressure vessel is designed for the storage of cryogenic gas, wherein, for the purposes of cooling the first cryogenic pressure vessel, gas is firstly conducted into the first cryogenic pressure vessel until the first cryogenic pressure vessel has been filled up to a predefined degree of filling with gas, and subsequently, the first cryogenic pressure vessel is at least partially relieved of pressure into the second pressure vessel. Owing to the relief of pressure, the remaining gas in the first pressure vessel, and thus the first pressure vessel itself, are additionally cooled. To achieve the maximum degree of filling, the process may be repeated until the maximum admissible pressure prevails in both pressure vessels. The relief of pressure may also be performed during a filling process of the first pressure vessel. Furthermore, the relief of pressure may be repeated at predefined intervals. The predefined degree of filling may for example be 10%, 20%, 30%, 50%, 70%, 90% or 100% of the maximum degree of filling. The relief of pressure may be performed until the first pressure vessel has reached a predefined temperature value.

The process may be correspondingly realized through control of valves.

The pressure vessel system may comprise a temperature measuring device for measuring the temperature of the first pressure vessel. In this way, the temperature of the first pressure vessel can be directly detected. It is thus possible for the time up to which the gas is conducted through the first pressure vessel and subsequently into the second pressure vessel to be determined particularly accurately or optimally. This leads to an increase in the amount of gas that can be stored in the first pressure vessel.

The pressure vessel system may comprise a pressure measuring device and/or a temperature measuring device for measuring the pressures or the temperature in the first pressure vessel and/or in the second pressure vessel. The control of valves for the purposes of opening or closing can thus be performed in a manner dependent on the degree of filling of the respective pressure vessel.

The predefined temperature may be the temperature of the gas before the gas is introduced into the first pressure vessel. Thus, gas can be conducted through the first pressure vessel until the first pressure vessel has reached the temperature of the gas, in particular of the cryogenic gas (before the introduction into the first pressure vessel). When the first pressure vessel has reached the temperature, the (cryogenic) gas can no longer cool the first pressure vessel and the pressure vessel no longer warms the gas. An advantage of this is that the amount of gas that can be stored in the pressure vessel is particularly greatly increased.

The pressure vessel system may furthermore comprise a heat exchanger, which is arranged between the first pressure vessel and the second pressure vessel and designed such that the heat exchanger warms the gas on the path from the first pressure vessel to the second pressure vessel or on the path from the second pressure vessel to the first pressure vessel. If the second pressure vessel is designed for storing CGH2, the gas can thus be conducted into the second pressure vessel, and stored there, in the warm state. An advantage of this is therefore that, firstly, the gas cools the first pressure vessel and, secondly, the same gas can subsequently be stored in the warm state (CGH2 state) in the second pressure vessel. Also, the gas from the second pressure vessel can be warmed on the path to the first pressure vessel in order to increase the pressure in the first pressure vessel with as little gas as possible from the second pressure vessel. The heat energy may originate inter alia from the cooling circuit of the vehicle or may be electrically generated, or may be supplied from already-warmed gas in a counterflow configuration.

The second pressure vessel may be designed for storing gas at a pressure up to 875 bar. An advantage of this is that the second pressure vessel is designed for storing e.g., CGH2, that is to say for storing a warm gas. Consequently, the gas serves for cooling the first pressure vessel, and the same gas can subsequently be stored in the warm or warmed state in the second pressure vessel for later use.

The second pressure vessel may be designed for storing gas at a considerably higher pressure than the first pressure vessel (for example up to 875 bar) and for cryogenic temperatures. An advantage of this is that the second pressure vessel is designed for storing for example CGH2, that is to say for storing a warm gas, but is also resistant to cryogenic temperatures. Consequently, the cryogenic gas serves for cooling the first pressure vessel, and the same gas can subsequently be supplied, in a still-cold or still-cryogenic state, to the second pressure vessel for later use, without the gas having to be additionally warmed. The gas may warm up, with a simultaneous build-up of pressure, in the closed-off second vessel. Ideally, the vessel is designed such that the pressure build-up by the cold gas can be stored without losses.

The object is also achieved by means of a motor vehicle having a pressure vessel system of the type.

The methods and the pressure vessel system are suitable in particular for utility vehicles, because more space (for the installation of the second pressure vessel) is available in these.

The technology disclosed here relates inter alia to a cryogenic pressure vessel or pressure tank. The cryogenic pressure vessel or pressure tank can store fuel in the liquid or supercritical state of aggregation. A supercritical state of aggregation refers to a thermodynamic state of a substance which has a higher temperature and a higher pressure than the critical point. The critical point refers to the thermodynamic state in which the densities of gas and liquid of the substance coincide, that is to say the substance is present in single-phase form. Whereas one end of the vapor pressure curve in a p-T diagram is characterized by the triple point, the critical point is represented by the other end. In the case of hydrogen, the critical point lies at 33.18 K and 13.0 bar. A cryogenic pressure vessel is in particular suitable for storing the fuel at temperatures that lie considerably below the operating temperature (this means the temperature range of the vehicle surroundings in which the vehicle is to be operated) of the motor vehicle, for example at least 50 Kelvin, preferably at least 100 Kelvin or at least 150 Kelvin below the operating temperature of the motor vehicle (generally approximately −40° C. to approximately +85° C.). The fuel may for example be hydrogen which is stored at temperatures of approximately 30 K to 360 K in the cryogenic pressure vessel. The pressure vessel may be used in a motor vehicle which is operated for example with compressed (compressed natural gas, CNG) or liquefied (LNG) natural gas. The cryogenic pressure vessel may in particular comprise an inner vessel which is designed for storage pressures up to approximately 350 barg, preferably up to approximately 500 barg, and particularly preferably up to approximately 700 barg. The cryogenic pressure vessel preferably comprises a vacuum with an absolute pressure in the range from 10⁻⁹ mbar to 10⁻¹ mbar, more preferably from 10⁻⁷ mbar to 10⁻³ mbar, and particularly preferably of approximately 10⁻⁵ mbar. The storage at temperatures (slightly) above the critical point has the advantage over storage at temperatures below the critical point that the stored medium is present in single-phase form. There is thus for example no boundary between liquid and gaseous.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a schematic view of a first embodiment of the pressure vessel system disclosed here.

FIG. 2 shows a schematic view of a second embodiment of the pressure vessel system disclosed here.

### DETAILED DESCRIPTION OF THE DRAWINGS

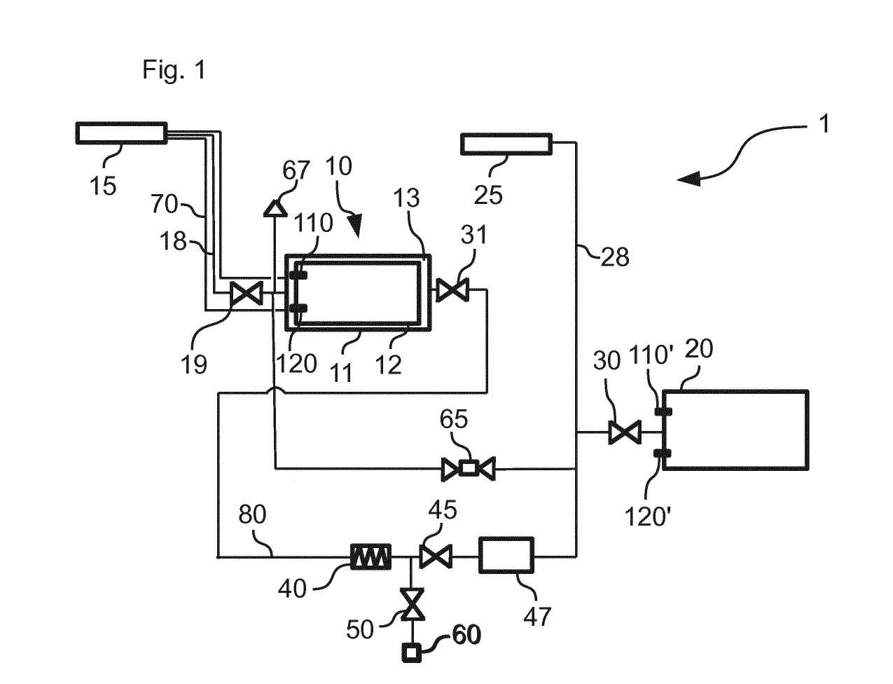

FIG. 1 shows a schematic view of a first embodiment of the pressure vessel system 1 disclosed here. The pressure vessel system 1 comprises two pressure vessels 10, 20. The first pressure vessel 10 is a pressure vessel for storing cryogenic gas (e.g., CcH2). The first pressure vessel 10 has an outer vessel 11 and an inner vessel 12. Between the outer vessel 11 and the inner vessel 12 there is arranged an evacuated space 13. The second pressure vessel 20 is a pressure vessel for storing (warm) gas (e.g. CGH2) at an extremely high pressure (700 bar technology). In this way, the pressure vessel system 1 can be filled using two different technologies, specifically cryogenic gas technology (e.g., 350 bar; CcH2) and 700 bar technology (CGH2). Since, in the case of tank filling using 700 bar technology, pressures higher than 700 bar may (briefly) prevail, the second pressure vessel is designed for pressures up to approximately 875 bar. It is also conceivable for the second pressure vessel to be designed only for pressures up to approximately 350 bar.

The pressure vessel system 1 has, for tank filling purposes, two different tank filling couplings 15, 25; specifically a first tank filling coupling 15 for tank filling or refilling with cryogenic hydrogen (CcH2) and a second tank filling coupling 25 for tank filling or refilling with warm hydrogen (700 bar technology; CGH2), that is to say hydrogen at a temperature of at least −40° C. The pressure vessel system 1 can thus be filled both at a filling station with 700 bar technology (CGH2) and at a filling station with cryogenic gas or hydrogen.

The line 18 from the first tank filling coupling 15 to the first pressure vessel 10 is equipped with an insulation or insulator 70 (e.g., vacuum insulation). In the line 18, there is arranged a first controllable tank shut-off valve 19 which can permit or shut off the inflow of gas to the first pressure vessel 10. The gas is conducted via a further line 80 to a consumer 60 (e.g., a fuel cell). In this part of the line 80, there is arranged a heat exchanger 40 (e.g., KWT or EWT). Furthermore, a pressure controller 50 is arranged in this part of the line 80. The heat exchanger 40 warms the cryogenic gas such that it can be used by the consumer 60.

Furthermore, the first pressure vessel 10 is connected to a discharge valve 65. In the event of an excessively high pressure of the gas in the first pressure vessel 10 (e.g., as a result of warming of the gas in the first pressure vessel 10 owing to an exchange of heat with the surroundings), gas is discharged out of the first pressure vessel 10 via the discharge valve 65. The second pressure vessel 20 can also discharge gas, that is to say allow the gas to emerge into the surroundings, via the discharge valve 65 or a second discharge valve (not shown) in the presence of an excessively high pressure of the gas. Furthermore, the pressure vessel system 1 has a safety valve 67. Via the safety valve 67, the gas flows out of the first pressure vessel 10 if a predetermined pressure difference in relation to the ambient pressure is exceeded.

The gas can (e.g., in the presence of an excessively high pressure in the first pressure vessel 10, so-called blow-off) be conducted out of the first pressure vessel 10 via the connecting line 80 into the second pressure vessel 20. Here, the gas can be warmed by the heat exchanger 40 that is arranged in the connecting line 80 between the first pressure vessel 10 and the second pressure vessel 20. In this way, the maximum standstill time of a motor vehicle with a pressure vessel system 1 disclosed here during which no gas is discharged to the surroundings can be lengthened.

The second pressure vessel 20 is connected to the second tank filling coupling 25. At the inlet/outlet of the second pressure vessel 20, there is arranged a second tank shut-off valve 30. The latter opens or closes in order to allow gas to flow into the second pressure vessel 20 or in order to prevent such a flow. The second pressure vessel 20 is designed for pressures up to approximately 875 bar. In particular, the second pressure vessel 20 is designed for so-called 700 bar hydrogen technology.

The first pressure vessel 10 is connected to the second pressure vessel 20 via a connecting line 80. In the connecting line 80, between the first pressure vessel 10 and the second pressure vessel 20, there is arranged a third shut-off valve 45 and a pressure-limiting valve 47. In this way, gas that is introduced via the first tank filling coupling 15 can be conducted via the connecting line 80 into the second pressure vessel 20. Likewise, gas that is introduced via the second tank filling coupling 25 can be conducted via the connecting line 80 into the first pressure vessel 10. The valve 47 limits the pressure of the gas from the first pressure vessel 10 to the admissible pressure of the second pressure vessel 20. Thus, both the first pressure vessel 10 and the second pressure vessel 20 can be filled both via the first tank filling coupling 15 (CcH2 technology) and via the second tank filling coupling 25 (700 bar CGH2 technology).

The gas can flow through the connecting line 80 also from the first pressure vessel 10 into the second pressure vessel 20 or vice versa.

The gas can be fed from both pressure vessels 10, 20 to the consumer.

The first pressure vessel 10 may have reached a relatively high temperature (as a result of an exchange of heat with the surroundings). It is then possible for only a small amount of gas or hydrogen to be stored in a warm first pressure vessel 10. The colder the first cryogenic pressure vessel 10 is, the more cryogenic gas can be accommodated or stored therein.

In the case of tank filling via the first tank filling coupling 15 with cryogenic gas, it is now possible for the gas to firstly be introduced into the first pressure vessel 10 and conducted out of the latter again, that is to say the gas is conducted through the first pressure vessel 10. This leads to cooling of the first pressure vessel 10 and to warming of the gas that is conducted through. The gas is subsequently warmed if necessary in the heat exchanger 40 and subsequently fed to and stored in the second pressure vessel 20.

In this way, the gas that has been warmed as a result of cooling of the first pressure vessel 10 is not stored in the first pressure vessel 10, but rather is discharged again after cooling the first pressure vessel 10. This is performed until the temperature of the first pressure vessel 10 has reached a predetermined temperature value (e.g., 180 K) or until the second pressure vessel 20 has reached a predetermined degree of filling (e.g., 90%, 95% or 99%). The gas used for cooling the first pressure vessel 10 is not discharged to the surroundings, but rather is stored in the second pressure vessel 20. From here, the gas can (at a later point in time) be provided to the consumer.

The gas may remain in the first pressure vessel 10 for a certain length of time (e.g., 0.1 s, 0.5 s, 1 s, 10 s, 30 s, 1 min) before the gas is conducted out of the first pressure vessel 10 again on a second side, arranged opposite the first side, and is conducted to the second pressure vessel 20. It is also conceivable for the gas to flow into the first pressure vessel 10 and flow out of the first pressure vessel 10 again immediately thereafter. The first pressure vessel 10 has an opening on a first side and has a second opening on a second side which is arranged opposite the first side. In this way, the gas can flow through the first pressure vessel 10 and remain in the first pressure vessel 10 only for as long as the gas requires to pass from the first opening to the second opening. On the second side of the first pressure vessel 10, there is arranged a fourth shut-off valve 31 for shutting off the line 80.

The gas may be conducted through the first pressure vessel 10 until the temperature of the first pressure vessel 10 (approximately) corresponds, or is equal to, the temperature of the cryogenic gas that is introduced through the (first or second) tank filling coupling 15, 25. When this condition has been met, the cryogenic gas can no longer (significantly) cool the first pressure vessel 10, and the gas no longer (significantly) warms up during the introduction, or after the introduction, of the gas into the first pressure vessel 10. Subsequently, that is to say when this condition has been met, the gas is conducted into the first pressure vessel 10 and is not (immediately subsequently or shortly thereafter) conducted out of the first pressure vessel 10 into the second pressure vessel 20.

In this way, the first pressure vessel 10 is cooled particularly effectively without gas being lost by being discharged to the surroundings. Consequently, a particularly large amount of (cold) gas can be stored in the first pressure vessel 10.

The pressure vessel system 1 comprises a temperature measuring device (not shown) for measuring the temperature of the first pressure vessel 10. In this way, it is possible to determine for how long the gas is conducted through the first pressure vessel 10, supplied to the second pressure vessel 20 and stored therein.

Subsequently, that is to say when the temperature of the first pressure vessel 10 has reached a predetermined temperature, the gas supplied through the first tank filling coupling 15 is supplied to and stored in the first pressure vessel 10.

The second pressure vessel 20 can be directly filled via the second tank filling coupling 25. It is also conceivable for the gas from the second pressure vessel 20 (or from the first tank filling coupling 15) to be cooled by means of the heat exchanger 40 and reduced in pressure by means of the pressure-limiting valve 47 and subsequently supplied to the first pressure vessel 10. In this way, gas can be conducted from the first pressure vessel 10 into the second pressure vessel 20 and vice versa.

The gas for cooling the first pressure vessel 10 may also originate from the second pressure vessel 20 (or from the second tank filling coupling 25), cooled by means of the heat exchanger 40, conducted through the first pressure vessel 10 and subsequently conducted into the second pressure vessel 20 again.

The gas from the second pressure vessel 20 may be used for increasing pressure in the first pressure vessel 10 if there is no longer sufficient pressure available in the first pressure vessel 10 for further withdrawal of the residual gas from the first pressure vessel 10. Here, the gas may be additionally warmed by means of the heat exchanger 40, such that less gas from the second pressure vessel 20 is required in the first pressure vessel 10 in order to increase the pressure of the gas in the first pressure vessel 10.

A temperature sensor 110 and a pressure sensor 120 are arranged in the first pressure vessel 10. By means of the temperature sensor 110, the temperature of the gas in the first pressure vessel 10 or the temperature of the first pressure vessel 10 itself (in particular the temperature of the liner) can be detected. The pressure sensor 120 serves for detecting the pressure of the gas in the first pressure vessel 10.

A temperature sensor 110′ and a pressure sensor 120′ are likewise arranged in the second pressure vessel 20. By means of the temperature sensor 110′, the temperature of the gas in the second pressure vessel 20 or the temperature of the second pressure vessel 20 itself (in the case of a cryogenic pressure vessel, in particular the temperature of the liner) can be detected. The pressure sensor 120′ serves for detecting the pressure of the gas in the second pressure vessel 20.

The pressure vessel system 1 comprises a control device (not shown). The control device is connected to the temperature sensors 110, 110′, to the pressure sensors 120, 120′, to the first tank shut-off valve 19, to the second tank shut-off valve 30, to the third shut-off valve 45, and to the fourth shut-off valve 31. The control device, which may comprise a computer or processor, detects the measurement values and performs open-loop or closed-loop control of the stated valves on the basis of the detected measurement values.

The gas may also firstly be conducted into the first pressure vessel 10 until a predetermined degree of filling of the first pressure vessel 10 is reached. Subsequently, the first pressure vessel 10 is at least partially relieved of pressure into the second pressure vessel 20, that is to say gas flows from the first pressure vessel 10 into the second pressure vessel 20. This may take place during the tank filling process of the first pressure vessel 10. The relief of pressure may be repeated until the first pressure vessel 10 has reached a predetermined temperature value.

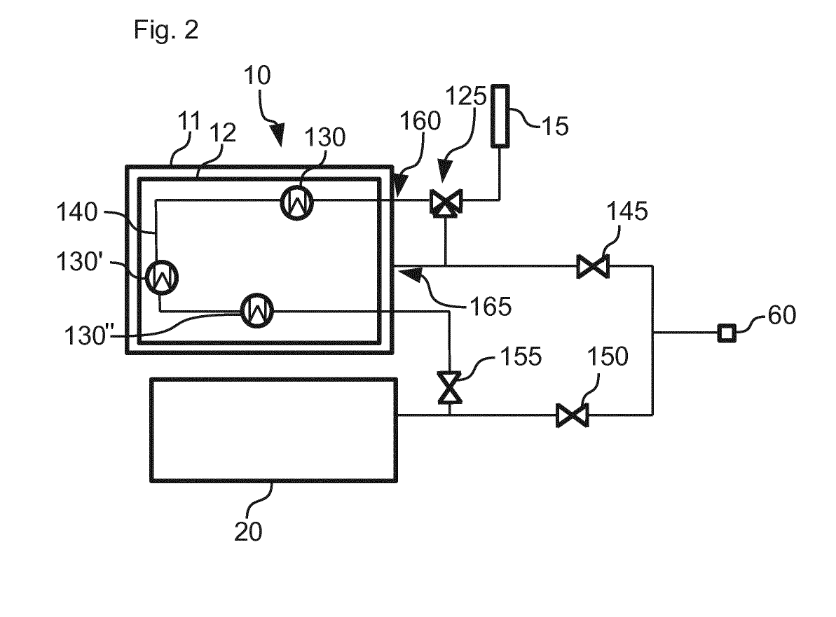

FIG. 2 shows a schematic view of a second embodiment of the pressure vessel system 10 disclosed here. The first pressure vessel 10 comprises one or more heat exchangers 130, 130′, 130″. The one or more heat exchangers 130, 130′, 130″ may in particular be non-identical to an inner tank heat exchanger for warming the cryogenic pressure vessel 10. The one or more heat exchangers 130, 130′, 130″ is or are in particular arranged close to the inner surface of the inner vessel 12 in order to realize a good heat transfer from the first pressure vessel 10 to the gas in the one or more heat exchangers 130, 130′, 130″. The cryogenic gas is conducted through the first pressure vessel 10 (before being fed to the second, warm pressure vessel 20), but through a dedicated line system 140 (within the first pressure vessel 10 or within the inner vessel 12 of the first pressure vessel 10) with one or more heat exchangers 130, 130′, 130″ and not through the volume in which the cryogenic gas is stored in the first pressure vessel 10. Here, there are two different inlets into the first pressure vessel 10: a first inlet 165 (inlet that is simultaneously an outlet) for the storage of the gas in the first pressure vessel 10, and a second inlet 160 for the flow of the gas through the one or more heat exchangers 130, 130′, 130″ of the first pressure vessel 10.

The gas passes from the first tank filling coupling 15 to a switchover valve 125. Depending on the position of the switchover valve 125, the gas passes to the second inlet 160 and thus into the line system 140, wherein the gas flows through the one or more heat exchangers 130, 130′, 130″ and subsequently via a fourth shut-off valve 155 into the second, warm pressure vessel 20. In the other position of the switchover valve 125, the gas flows through the first inlet 165 into the first pressure vessel 10 and is stored therein. Through the first inlet 165, which is simultaneously an outlet, the gas flows out of the first pressure vessel 10 again. When the third tank shut-off valve 145 is open, the gas passes to the consumer 60.

The switchover valve 125 is switched over when the first pressure vessel 10 has reached or fallen below the predefined temperature. Subsequently, the gas is conducted through the first inlet 165 into the first pressure vessel 10, where it is stored. It is also conceivable for the switchover valve 125 to be switched over when the second pressure vessel 20 has reached a predefined degree of filling.

The position of a fifth tank shut-off valve 150 determines whether the gas can flow from the second pressure vessel 20 to the consumer 60. A shut-off valve 155 is situated in the line between the line system 140 and the second pressure vessel 20.

It is however also conceivable for the gas to be conducted through the volume in which the cryogenic gas is later stored in the first pressure vessel 10. Here, as shown in FIG. 1, there is only one inlet for the gas into the first pressure vessel, and no dedicated line system within the first pressure vessel 10.

### LIST OF REFERENCE CHARACTERS

1 Pressure vessel system
10 First pressure vessel
11 Outer vessel
12 Inner vessel
13 Evacuated space
15 First tank filling coupling
18 Line from the first tank filling coupling to the first pressure vessel
19 First tank shut-off valve
20 Second pressure vessel
25 Second tank filling coupling
28 Line from the second tank filling coupling to the second pressure vessel
30 Second tank shut-off valve
31 Fourth shut-off valve
40 Heat exchanger
45 Third shut-off valve
47 Pressure-limiting valve
50 Pressure controller
60 Consumer
65 Discharge valve
67 Safety valve
70 Insulator
80 Connecting line between the first pressure vessel and the second pressure vessel
110, 110′ Temperature sensor
120, 120′ Pressure sensor
125 Switchover valve
130, 130′,
130″ Heat exchanger
140 Line system
145 Fourth tank shut-off valve
150 Fifth tank shut-off valve
155 Shut-off valve

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for cooling a first cryogenic pressure vessel arranged in a motor vehicle, wherein the first cryogenic pressure vessel is designed for the storage of cryogenic gas and wherein the cryogenic gas is a fuel, comprising the acts of:
gas is firstly conducted through the first cryogenic pressure vessel for the purpose of cooling the first cryogenic pressure vessel and is subsequently fed to a second pressure vessel for the purpose of storing the gas, until a temperature of the first cryogenic pressure vessel has reached a predetermined temperature value or until the second pressure vessel has reached a predefined degree of filling with the gas.

2. The method as claimed in claim 1, wherein the predefined temperature is a temperature of the gas before the gas is firstly conducted through the first cryogenic pressure vessel.

3. The method as claimed in claim 1, wherein the gas is warmed after being conducted through the first cryogenic pressure vessel and before the gas is fed to the second pressure vessel.

4. The method as claimed in claim 2, wherein the gas is warmed after being conducted through the first cryogenic pressure vessel and before the gas is fed to the second pressure vessel.

5. The method as claimed in claim 1, wherein the gas is cryogenic gas before the gas is conducted through the first cryogenic pressure vessel.

6. A method for cooling a first cryogenic pressure vessel, wherein the first cryogenic pressure vessel is designed for the storage of cryogenic gas, comprising the acts of:
for a purpose of cooling the first cryogenic pressure vessel, gas is firstly conducted into the first cryogenic pressure vessel until the first cryogenic pressure vessel has been filled up to a predefined degree of filling with the gas, and subsequently, the first cryogenic pressure vessel is at least partially relieved of pressure into a second pressure vessel.

7. A motor vehicle, comprising:
a pressure vessel system, wherein the pressure vessel system includes:
a first cryogenic pressure vessel for storage of cryogenic gas, wherein the cryogenic gas is a fuel; and
a second pressure vessel for storage of gas;
wherein the pressure vessel system is configured such that, for a purpose of cooling the first cryogenic pressure vessel, gas is firstly conducted through the first cryogenic pressure vessel and is subsequently fed to the second pressure vessel, until a temperature of the first cryogenic pressure vessel has reached a predetermined temperature value or until the second pressure vessel has reached a predefined degree of filling with the gas.

8. The motor vehicle as claimed in claim 7 further comprising a temperature measuring device, wherein a temperature of the first cryogenic pressure vessel is measurable by the temperature measuring device.

9. The motor vehicle as claimed in claim 7, wherein the predefined temperature is a temperature of the gas before the gas is firstly conducted through the first cryogenic pressure vessel.

10. The motor vehicle as claimed in claim 8, wherein the predefined temperature is a temperature of the gas before the gas is firstly conducted through the first cryogenic pressure vessel.

11. The motor vehicle as claimed in claim 7 further comprising a heat exchanger which is disposed between the first cryogenic pressure vessel and the second pressure vessel, wherein the gas on a path from the first cryogenic pressure vessel to the second pressure vessel, or on a path from the second pressure vessel to the first cryogenic pressure vessel, is warmable by the heat exchanger.

12. The motor vehicle as claimed in claim 8 further comprising a heat exchanger which is disposed between the first cryogenic pressure vessel and the second pressure vessel, wherein the gas on a path from the first cryogenic pressure vessel to the second pressure vessel, or on a path from the second pressure vessel to the first cryogenic pressure vessel, is warmable by the heat exchanger.

13. The motor vehicle as claimed in claim 9 further comprising a heat exchanger which is disposed between the first cryogenic pressure vessel and the second pressure vessel, wherein the gas on a path from the first cryogenic pressure vessel to the second pressure vessel, or on a path from the second pressure vessel to the first cryogenic pressure vessel, is warmable by the heat exchanger.

14. The motor vehicle as claimed in claim 7, wherein the second pressure vessel is designed for the storage of gas at a pressure of up to 875 bar.

15. The motor vehicle as claimed in claim 8, wherein the second pressure vessel is designed for the storage of gas at a pressure of up to 875 bar.

16. The motor vehicle as claimed in claim 9, wherein the second pressure vessel is designed for the storage of gas at a pressure of up to 875 bar.

17. The motor vehicle as claimed in claim 11, wherein the second pressure vessel is designed for the storage of gas at a pressure of up to 875 bar.

18. The motor vehicle as claimed in claim 7, wherein the first cryogenic pressure vessel has an inner vessel and has an outer vessel which is insulated with respect to the inner vessel.

19. The motor vehicle as claimed in claim 8, wherein the first cryogenic pressure vessel has an inner vessel and has an outer vessel which is insulated with respect to the inner vessel.

20. The motor vehicle as claimed in claim 9, wherein the first cryogenic pressure vessel has an inner vessel and has an outer vessel which is insulated with respect to the inner vessel.
